(19) United States
(12) Patent Application Publication
(10) Pub. No.: US 2006/0203475 A1
(43) Pub. Date: Sep. 14, 2006

(54) Visual recognition device

(76) Inventor: June Tarian, Troy, MI (US)

Correspondence Address: JAMES RAY & ASSOCIATES, 2640 PITCAIRN ROAD, MONROEVILLE, PA, 15146, US

(21) Appl. No.: 11/365,192

(22) Filed: Mar. 1, 2006

Related U.S. Application Data
(60) Provisional application No. 60/660,109, filed on Mar. 9, 2005.

(51) Int. Cl. F21L 4/00

(52) U.S. Cl. 362/157

(57) ABSTRACT

A portable visibility system for providing visible recognition to a person or equipment in a dimly lit area. The portable visibility system comprises a reflective coil having a predetermined length and a predetermined width. There are a plurality of mini lights disposed one of on and in such reflective coil. A wiring system is disposed one of on and in such reflective coil and engageable with each of the plurality of mini lights. A power source is connected to the wiring system and disposed one of on and in such reflective coil and a switch is disposed one of on and in such reflective coil, the switch is engageable with the power source and the wiring system for turning the plurality of mini lights on and off.

### CROSS REFERENCE TO RELATED APPLICATIONS

This application is closely related to and claims benefit from U.S. Provisional Application Ser. No. 60/660,109 filed Mar. 9, 2005.

### FIELD OF THE INVENTION

The present invention relates, in general, to a visual protection device, and, more particularly, this invention relates to a portable series of lights to provide a walker at night with visible recognition.

### BACKGROUND OF THE INVENTION

Pedestrians who are on the road at night whether they must be out because of work requirements or for exercise reasons or just simply the need to walk because of unavailability of vehicular transportation are constantly at risk from passing motorists. One major problem that such pedestrian has between the hours of dusk till dawn is the difficulty of being seen by the motorist.

Most people learned a long time ago that walkers should always walk on the left so as to face oncoming traffic. However, this is not sufficient. Even facing traffic so that the pedestrian can see the vehicles coming does not guarantee safety. In the evening hours it is not always possible for the vehicular traffic to see the pedestrians as easily as the pedestrians can see the cars. This is particularly true if the pedestrian is wearing dark clothes and it is true even if the clothes are not dark but the evening is very dark because of rain or overcast skies. Pedestrians are not easily spotted on the side of the road.

Thus it would be advantageous if there were a portable means that pedestrians could have that would insure that they are seen by motorists.

### SUMMARY OF THE INVENTION

The present invention provides a portable visibility system for providing visual recognition to a person or equipment in a dimly lit area. The portable visibility system comprises a reflective coil having a predetermined length and a predetermined width. There are a plurality of mini lights disposed one of on and in such reflective coil. A wiring means is disposed one of on and in such reflective coil and engageable with each of the plurality of mini lights. A power source is connected to the wiring means disposed one of on and in such reflective coil and a switch means is disposed one of on and in such reflective coil, the switch means is engageable with the power source and the wiring means for turning the plurality of mini lights on and off.

### OBJECTS OF THE INVENTION

The primary object of the present invention is to provide visible recognition to a person or equipment in a dimly lit area.

Another object of the present invention is to provide a multi-use reflective twinkling strip that can be worn by pedestrians.

Still another object of the present invention is to provide a multi-use reflective twinkling strip that can be worn on various parts of the body like arms or legs.

Yet another object of the present invention is to provide a multi-use reflective twinkling strip that can easily be carried and stored when not in use.

Another object of the present invention is to provide a multi-use reflective twinkling strip that can also be used on bicycles, canes, wheelchairs, strollers and even handrails or mailbox posts.

In addition to the various objects and advantages of the present invention which have been described in detail above it should be obvious that those persons who are skilled in the relevant art can envision other objects and a advantages of the invention from the following more detailed description of the invention, particularly, when such description is taken in conjunction with the attached drawing Figures and with the appended claims.

### BRIEF DESCRIPTION OF THE DRAWINGS

FIG. 1 is a partial perspective view of a person's body showing various places where such life lights can be positioned.

FIG. 2 is a partial perspective view of a coil of life lights according to an embodiment of the invention.

FIG. 3 is a partial perspective view of a coil of the portable visibility system according to an alternate embodiment of the invention.

FIG. 4 is a partial perspective view of a coil of life lights used with a post.

FIG. 5 is a partial perspective view of a coil of life lights used with a personal vehicle.

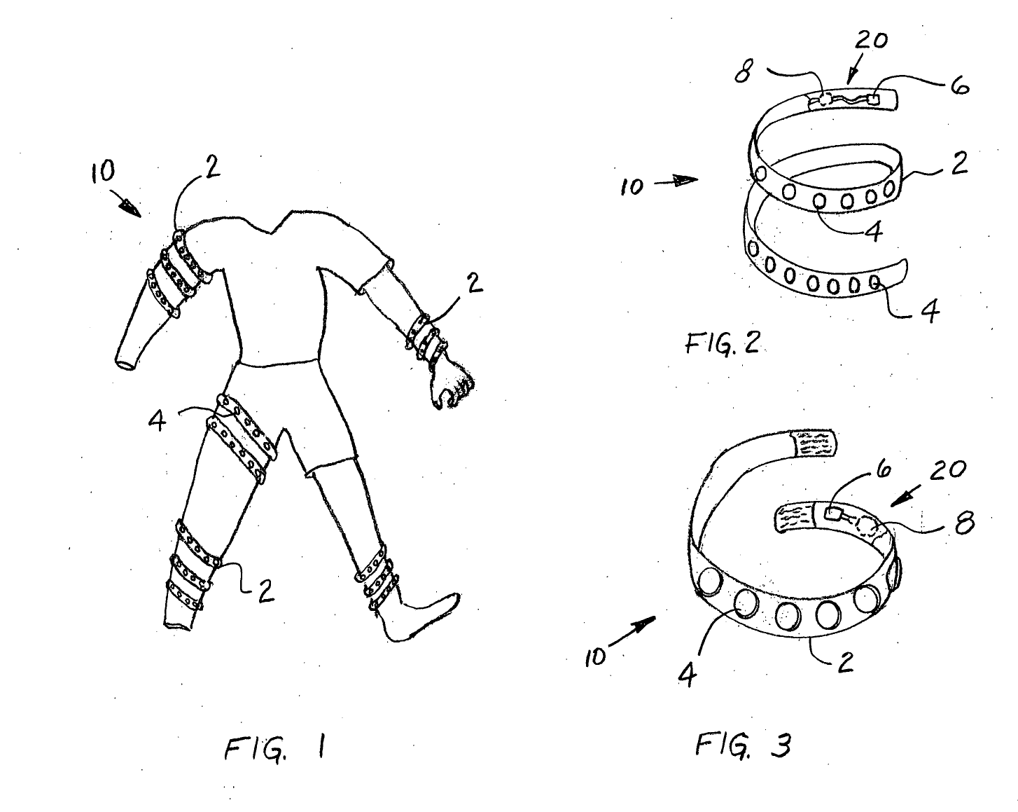

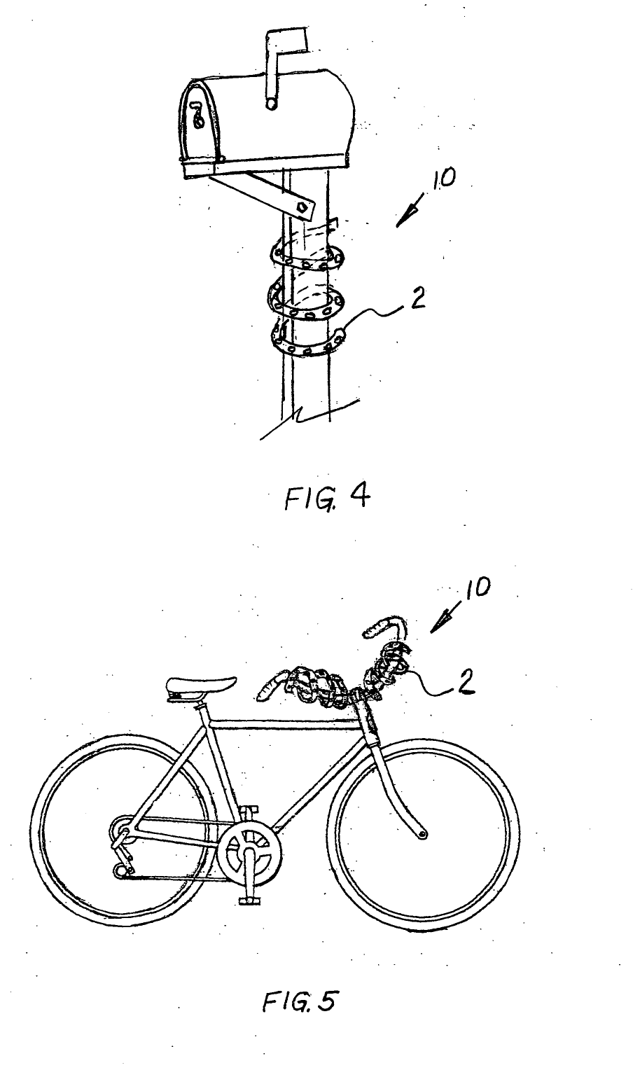

### BRIEF DESCRIPTION OF THE PRESENTLY PREFERRED AND VARIOUS ALTERNATIVE EMBODIMENTS OF THE INVENTION

Prior to proceeding to the more detailed description of the present invention it should be noted that for the sake of clarity and understanding of the invention identical components which have identical reference functions have been identified with identical reference numerals through out the several views illustrated in the drawings.

The present invention provides a portable visibility system, generally designated 10, for providing visible recognition to a person or equipment in a dimly lit area. The portable visibility system 10 comprises a reflective coil 2 having a predetermined length and a predetermined width. There are a plurality of mini lights 4 disposed one of on and in such reflective coil 2. A wiring means, generally designated 20, is disposed one of on and in such reflective coil and engageable with each of the plurality of mini lights 4. A power source 6 is connected to the wiring means 20 disposed one of on and in such reflective coil 2 and a switch means 8 is disposed one of on and in such reflective coil 2, the switch means 8 is engageable with the power source 6 and the wiring means 20 for turning the plurality of mini lights 4 on and off.

Such reflective coil 2 is designed to coil around one of a person's arm and leg. Such coil 2 is conveniently worn over clothing or on bare skin for warm weather activities. As seen in FIG. 1 there are many places that such reflective coil 2 can be worn. Since the coil is wrapped around an arm or leg when worn by an individual the person is not encumbered by carrying something and, thus, the person's hands are free and the person doesn't have to worry about being seen. Further, since the reflective coil wraps around a person's limb there is provided visibility from a 360 degree vantage. The lights can be seen in any direction. It is also an embodiment of the invention that such mini lights 4 are twinkling lights, which also aids in catching the eyes of motorists. The reflective coil 2 also provides for easy storage since the reflective coil 2 easily recoils for ease of storage when not in use. Thus, such reflective coil 2 can be stored in a pocket, a purse or a fanny pack or other similar places.

The reflective coil 2, according to the present invention, is weather proof so that the coil 2 may be used in rainy weather or other inclement conditions without a need to worry about the reflective coil 2.

The reflective coil 2 is also designed to reflect light from headlights, flashlights, street lights and other light sources to further enhance the visibility of the person wearing such portable visibility system 10.

As stated previously such portable visibility system 10 includes a power source 6. It is presently preferred that such power source 6 is a battery and, further, that such battery is a mini battery such as a watch or a hearing aid battery.

All the discussion has been in the use of such portable visibility system 10 with a person out at night, however, such portable visibility system also can be used with stationary objects such as mailbox posts and handrails so as to alert someone of the presence of such nonmovable items.

The portable visibility system 10 can also be used to provide visual protection on personal vehicles such as bicycles, strollers, scooters and wheelchairs. In these instances the reflective coil or coils 2 wraps around predetermined locations on such personal vehicles.

It is within the scope of the invention that such mini lights 4 be colored lights and it is presently preferred that such colors be one of amber and red or combinations thereof.

An alternate embodiment of the invention provides that such reflective coil 2 be secured to either a person or such objects mentioned previously by means of Velcro (hook and loop fasteners) or double faced tape.

While in accordance with the patent statutes a presently preferred embodiment of the invention has been illustrated in the attached drawing figures which have been described above, it should be obvious that various other modifications and alterations can be envisioned by those persons who are skilled in the relevant art without departing from the spirit of the invention.

I claim:

1. A portable visibility system for providing visual recognition to one of a person and equipment located in a dimly lit area, said visibility system comprising:
(a) a reflective coil having a predetermined length and a predetermined width;
(b) a plurality of mini lights disposed one of on and in said reflective coil;
(c) a wiring means disposed one of on and in said reflective coil and engageable with each of said plurality of mini lights;
(d) a power source connected to said wiring means disposed one of on and in said reflective coil; and
(e) a switch means disposed one of on and in said reflective coil, said switch means engageable with said power source and said wiring means for turning said plurality of mini lights on and off.

2. The portable visibility system, according to claim 1, wherein said reflective coil is designed to coil around one of a person's arm and leg.

3. The portable visibility system, according to claim 1, wherein said mini lights are twinkling lights.

4. The portable visibility system, according to claim 1, wherein said reflective coil reflects light from headlights, flashlights, street lights and other light sources.

5. The portable visibility system, according to claim 1, wherein said power source is a battery.

6. The portable visibility system, according to claim 5, wherein said battery is selected from one of a watch and hearing aid battery.

7. The portable visibility system, according to claim 1, wherein said reflective coil is used to provide visual recognition on personal vehicles such as bicycles, strollers, scooters and wheelchairs.

8. The portable visibility system, according to claim 7, wherein said reflective coil is disposed on at least one predetermined location on such personal vehicle.

9. The portable visibility system, according to claim 1, wherein said reflective coil is used to visually alert someone of nonmovable objects such as mailbox posts and handrails.

10. The portable visibility system, according to claim 1, wherein said reflective coil is secured by means of one of hook and loop fasteners and double faced tape.

11. The portable visibility system, according to claim 1, wherein said mini lights are colored.

12. The portable visibility system, according to claim 11, wherein said colored mini lights are at least one of amber and red.

13. The portable visibility system, according to claim 1, wherein said reflective coil when not in use easily recoils for ease of storage.

14. The portable visibility system, according to claim 1, wherein said reflective coil is weather resistant.

15. The portable visibility system, according to claim 1, wherein said reflective coil provides personal visibility recognition from a 360 degree vantage.
